(19) United States
(12) Patent Application Publication
(10) Pub. No.: US 2016/0164952 A1
(43) Pub. Date: Jun. 9, 2016

(54) Systems and Methods For Information Centric Networking

(71) Applicant: Telefonaktiebolaget L M Ericsson (publ), Stockholm (SE)

(72) Inventors: Zoltán TURÁNYI, Szentendre (HU); Börje OHLMAN, Bromma (SE)

(73) Assignee: Telefonaktiebolaget L M Ericsson (publ), Stockholm (SE)

(21) Appl. No.: 14/561,548

(22) Filed: Dec. 5, 2014

(51) Int. Cl. H04L 29/08

(52) U.S. Cl. CPC H04L 67/10

(57) ABSTRACT

A networking approach that maintains the benefits of ICN, but that can also be used to implement N-way commit protocols. In one aspect, a method performed by a routing apparatus is provided. In some embodiments, the method includes the routing apparatus receiving a request message transmitted by a requesting apparatus, the request message comprising a first content name. The routing apparatus forwards the first request message towards a publishing apparatus. After forwarding the first request message, the routing apparatus receives, via a network interface, a first response message transmitted by the publishing apparatus, the first response message comprising the first content name and a second content name. The routing apparatus forwards the first response message towards a requesting apparatus and links the second content name with a network interface identifier for identifying the interface via which the routing apparatus received the first response message.

### TECHNICAL FIELD

This disclosure relates to information centric networking (ICN), examples of which include Content Centric Networking (CCN) and Named Data Networking (NDN).

### BACKGROUND

Information Centric Networking (ICN) is an approach to evolve the Internet infrastructure away from a host-centric paradigm to a network architecture in which the focal point is “named information” (or named content or data). Instead of focusing on connecting communicating endpoints (which is the focus of traditional networking protocols, such as the Internet Protocol (IP)), ICN focuses on the Content Object (i.e., unit of data, such as a file, a database record, a sensor reading, dynamically generated data, or any other piece of data) that should be retrieved. In ICN, messages are routed based on names of Content Objects rather than on endpoint addresses referring to physical boxes. Two examples of ICN are Content Centric Networking (CCN) and Named Data Networking (NDN).

In CCN, a data requester obtains a Content Object by transmitting an Interest message containing the name of the Content Object. The Interest message is routed by routing apparatuses (a.k.a., routing nodes) within a network towards a publishing apparatus identified as being a source of the Content Object. When the publishing apparatus receives an Interest message, the publishing apparatus typically obtains (e.g., retrieves, generates, selects) the named Content Object, generates a Data message containing the name of the Content Object and the obtained Content Object, and transmits the Data message to the routing apparatus from which the publishing apparatus received the Interest message. When a routing apparatus receives an Interest message, the routing apparatus may check to see if it has an unexpired cached copy of the Content Object named in the Interest message. If so, it may respond to the Interest message with a Data message containing the requested Content Object and the Interest message will not be forwarded any further.

In CCN, the routing of an Interest message is helped by the name being a structured name (similar to domain names, but with richer syntax). Routing apparatuses maintain a Forwarding Information Base (FIB) about where to forward which name or name prefix. The routing apparatuses along the path of the Interest message keep a record of the Interest messages they have forwarded (where it came from and what Content Object it was naming) in a Pending Interest Table (PIT). If a subsequent Interest message containing the same Content Object name arrives at the routing apparatus, the routing apparatus does not forward the Interest message, but may update its PIT so that the requester that originated the subsequent Interest message will receive the requested Content Object. This is called Interest aggregation. This way the PIT entries for the same name may form a tree in the network with receivers at the leafs.

As mentioned above, when an Interest message reaches an endpoint (e.g., a publishing apparatus or a router having a cached copy), the endpoint responds to the Interest message by transmitting a Data message containing the requested Content Object and the name of the requested Content Object. This Data message is propagated backwards along the same path the Interest message traversed. A routing apparatus learns the path (or, more precisely, the next hop(s)) by matching the Content Object name included in the Data message with data from the PIT maintained by the routing apparatus. If there were multiple Interests arriving at a router for this name, the Data message containing the Content Object is replicated towards each direction, where the Interest messages came from. After forwarding a Content Object matching a pending Interest, the routers delete the corresponding entry in the PIT, thus these entries are expected to be short-lived. When the requester that transmitted the original Interest message receives the Data message containing the Content Object the transaction is considered as terminated.

### SUMMARY

While CCN and other types of ICN are especially suited for content distribution, they are less suited for other types of communication. As discussed above, CCN operates using Interest/Data message pairs. It is a fairly generic communication primitive that can be used as a building block to many complicated communication dialogs. For example, one-way, live video transmission can be implemented by naming each chunk of the video with its own name and using a series of Interest/Data message exchanges to deliver each video chunk. However, the Interest/Data message dialog is not well suited to some situations. For example, a three-way commit protocol is difficult to implement using Interest messages and Data messages.

Accordingly, this disclosure provides a networking approach that maintains the benefits of ICN, but that can also be used to implement N-way commit protocols. In one aspect, a method, performed by a requesting apparatus, for information centric networking is provided. In some embodiments, the method includes the requesting apparatus transmitting a first request message towards a routing apparatus. The routing apparatus forwards the first request message towards a publishing apparatus. The first request message contains a first content name. After transmitting the first request message, the requesting apparatus receives a first response message transmitted by the publishing apparatus in response to the publishing apparatus receiving the first request message. The first response message containing the first content name and a second content name. In response to receiving the first response message, the requesting apparatus: a) obtains content data using the second content name; b) generates a second response message comprising the obtained content data and the second content name, and c) transmits towards the routing apparatus the second response message.

In some embodiments, the first request message is a CCN Interest message and the first content name is a name for identifying a requested content object.

In some embodiments, the second response message further comprises a third content name and the second response message is a Combined Message. In such an embodiment, the method may further include the requesting apparatus receiving a third response message transmitted by the publishing apparatus in response to the publishing apparatus receiving the second response message, wherein the third response message comprises the third content name and a content object obtained by the publishing apparatus using the third content name. In some embodiments, the third response message further comprises a fourth content name. In such an embodiment, the method may further include the requesting apparatus performing the following steps in response to receiving the third response message: d) obtaining content data using the fourth content name; e) generating a fourth response message comprising the fourth content name and the content data obtained using the fourth content name, and f) transmitting towards the routing apparatus the fourth response message.

In another aspect, a method, performed by a routing apparatus, for information centric networking is provided. In some embodiments, method includes: the routing apparatus receiving a first request message transmitted by a first requesting apparatus. The first request message containing a first content name. The routing apparatus forwards the first request message towards a publishing apparatus. After forwarding the first request message towards the publishing apparatus, the routing apparatus receives, via a network interface, a first response message transmitted by the publishing apparatus in response to the first request message. The first response message containing the first content name and a second content name. The routing apparatus forwards the received first response message towards the first requesting apparatus and links the second content name with a network interface identifier for identifying the interface via which the routing apparatus received the first response message.

In some embodiments, the first response message further comprises a content object obtained by the publishing apparatus using the first content name. In some embodiments, the method further includes, prior to receiving the first response message, the routing apparatus receiving a second request message transmitted by a second requesting apparatus, the second request message comprising the first content name. In response to receiving the second request message, the routing apparatus links the first content name with a network interface identifier for identifying the interface via which the routing apparatus received the second request message. The routing apparatus forwards the first response message towards the second requesting apparatus. In some embodiments, the routing apparatus determines the number of interfaces associated with the second content name and sets a counter to a value based on the determined number of interfaces. The routing apparatus may receive a third response message comprising the second content name, and, in response to receiving such a third response message, the routing apparatus determines the interface identifier with which the second content name is linked and adjusts the value of the counter (e.g., decrements the counter).

In some embodiments, the step of linking the second content name with a network interface identifier for identifying the interface via which the routing apparatus received the first response message comprises the routing apparatus adding to a network interest database a record comprising the second content name and the interface identifier. In some embodiments, the method also includes the routing apparatus determining whether the value of the counter has reached a predetermined threshold, and the routing apparatus removing the record form the interest database as a result of determining that the value of the counter has reached the predetermined threshold.

In another aspect, a method, performed by a publishing apparatus, for information centric networking is provided. In some embodiments, method includes the publishing apparatus receiving a first request message transmitted by a requesting apparatus. The first request message containing a first content name. In response to receiving the first request message, the publishing apparatus: a) generates a first response message based on the first content name, and b) transmits the first response message. The first response message contains the first content name and a second content name. After transmitting the first response message, the publishing apparatus receives a second response message transmitted by the requesting apparatus in response to the requesting apparatus receiving the first response message transmitted by the publishing apparatus. The second response message contains the second content name and content data associated with the second content name.

In some embodiments, the method further includes the publishing apparatus using the first content name to obtain a first content object, and the first response message further comprises the first content object.

In some embodiments, the second response message further comprises a third content name and the second response message is a Combined Message. In such an embodiment, the method may further include the publishing apparatus, in response to receiving the second response message, 1) obtaining a content object using the third content name, 2) generating a third response message comprising the third content name, a fourth content name, and the content object obtained using the third content name, and 3) transmitting the third response message.

The above and other aspects and embodiments are described below.

### BRIEF DESCRIPTION OF DRAWINGS

FIG. 1 illustrates a system according to some embodiments.

FIG. 2 is a flow chart illustrating a process according to some embodiments.

FIG. 3 is a message flow diagram illustrating a message flow according to some embodiments.

FIG. 4 is a flow chart illustrating a process according to some embodiments.

FIG. 5 is a flow chart illustrating a process according to some embodiments.

FIG. 6 is a message flow diagram illustrating a message flow according to some embodiments.

FIG. 7 is a message flow diagram illustrating a message flow according to some embodiments.

FIG. 8 is a diagram illustrating a requesting apparatus according to some embodiments.

FIG. 9 is a diagram illustrating a routing apparatus according to some embodiments.

FIG. 10 is a diagram illustrating a publishing apparatus according to some embodiments.

### DETAILED DESCRIPTION

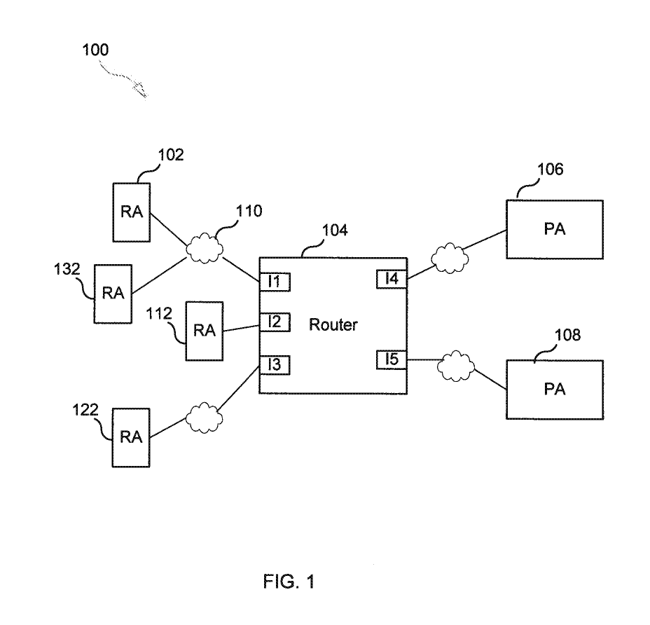

FIG. 1 illustrates a system 100 according to some embodiments. System 100 includes a plurality of requesting apparatuses (RAs) 102, 112, 122, 132, a plurality of routing apparatuses 104 (only one is shown in FIG. 1), and a plurality of publishing apparatuses (PA) 106, 108. In some embodiments, an RA is a conventional computing device (e.g., smartphone, personal computer, tablet, phablet, etc.). Similarly, a PA may also comprise a conventional computing device (e.g., a high capacity server computer). Routing apparatus 104 (or “router 104” for short) may comprise a conventional networking apparatus, such as a router, switch, gateway or bridge.

As shown in FIG. 1, a routing apparatus 104 of system 100 may be connected (directly or indirectly via one or more other routing apparatuses) to one or more of the plurality of RAs and it may be connected (directly or indirectly via one or more other routing apparatuses) to one or more of the plurality of PAs. In the specific example shown, routing apparatus 104 has a plurality of network interfaces (I1 to I5), where: interface I1 is connected to RAs 102, 132 via a network 110 (e.g., a network in the Internet) that may include one or more other routing apparatuses that function in the same manner as routing apparatus 104; interface I2 is directly connected to RA 112; interface I3 is connected to RA 122 via a network that may include one or more other routing apparatuses that function in the same manner as routing apparatus 104; interface I4 is connected to PA 106 via a network that may include one or more other routing apparatuses that function in the same manner as routing apparatus 104; and interface I5 is connected to PA 108 via a network that may include one or more other routing apparatuses that function in the same manner as routing apparatus 104.

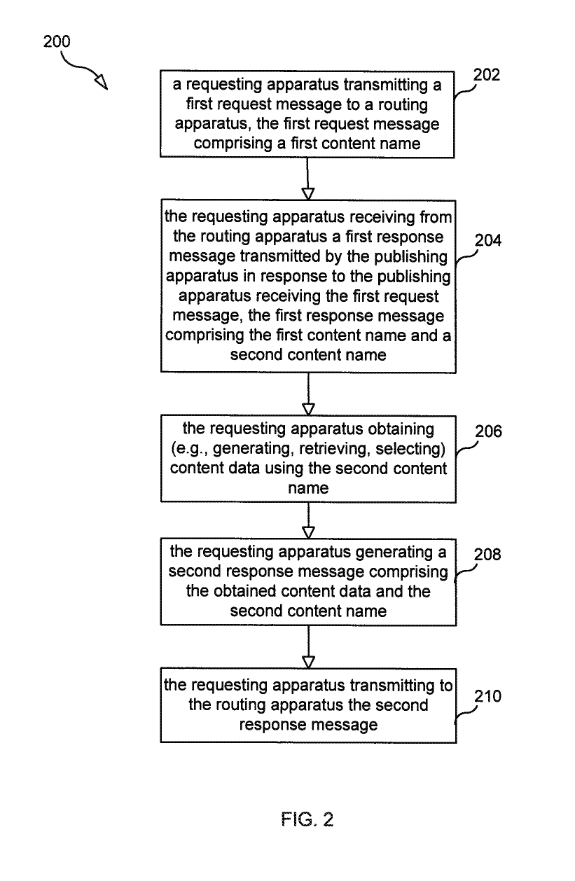

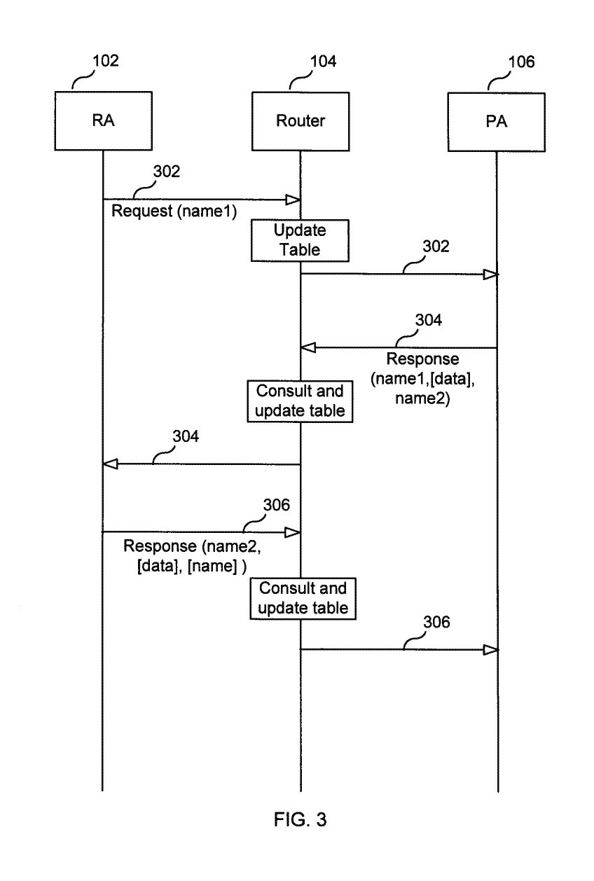

FIG. 2 is a flow chart illustrating a process 200, according to some embodiments, performed by RA 102. In step 202, RA 102 transmits a first request message 302 (see the message flow diagram shown in FIG. 3). First request message 302 may be a CCN Interest message. As shown in FIG. 3, first request message 302 includes a first content name (e.g., the name of a Content Object) (in this example the first content name is “name1”), and this first request message 302 is received by router 104 and forwarded by router 104 towards PA 106. In response to receiving first request message 302, PA transmits a first response message 304, which is received by router 104 and forwarded by router 104 towards RA 102. In this example, first response message 304 includes not only a Data_name (i.e., the first content name, name1), but also an Interest_name (i.e., a second content name, name2). First response message 304 may also include a Content Object (e.g., data retrieved by PA 106 using name1). Accordingly, first response message 304 can be thought of as a message that combines a CCN Interest message with a CCN Data message. Accordingly, response message 304 may be referred to as a “Combined Message.” As illustrated herein, any response message can be a Combined Message, thereby enabling implementation of an N-way commit protocol.

In some embodiments, response message 304 is structured such that it includes a data field or information element (IE) for containing a previously requested Content Object, a content object name field or IE for containing the name of the previously requested Content Object stored in the data field, and a data request field or IE for containing the content name of a currently requested data object. Thus, in this embodiment, name1 is stored in the content object name field or IE and name2 is stored in the data request field or IE.

In other embodiments, response message 304 includes a set of one or more attribute-value pairs (AVPs), which set of AVPs includes at least one AVP where the attribute name of this AVP is “data_name” and the value of this AVP is the name of a previously requested Content Object. The set of AVPs may also include: a second AVP where the attribute name of the second AVP is “requested_content_object” and the value of the second AVP is the requested Content Object; and a third AVP where the attribute name of the third AVP is “currently_requested_data” and the value of the third AVP is the name of a currently requested Content Object. Thus, in this embodiment, name1 is the value of the first AVP and name2 is the value of the third AVP.

The value stored in the data request field or IE and the value associated with the currently_requested _object attribute is termed the “Interest_name”; and the value stored in the content object name filed and the value associated with the data_name attribute is termed the “Data_name.” Accordingly, a response message contains, at the least, a Data_name, but it also may contain an Interest_name.

In step 204, RA 102 receives from router 104 first response message 304, which was transmitted by PA 106 in response to PA 106 receiving the request message 302. In response to receiving the first response message, the requesting apparatus (i.e., RA 102): a) obtains (e.g., generates, retrieves, selects) content data using the second content name (i.e., “name2”) (step 206); b) generates a second response message 306 comprising the obtained content data and the second content name (step 208); and c) transmits to router 104 the second response message 306 (step 210). In some embodiments, step 206 is omitted. As indicated in FIG. 3, second response message 306 may be a Combined Message (i.e., second response message 306 may include not only a Data_name, but also an Interest_name).

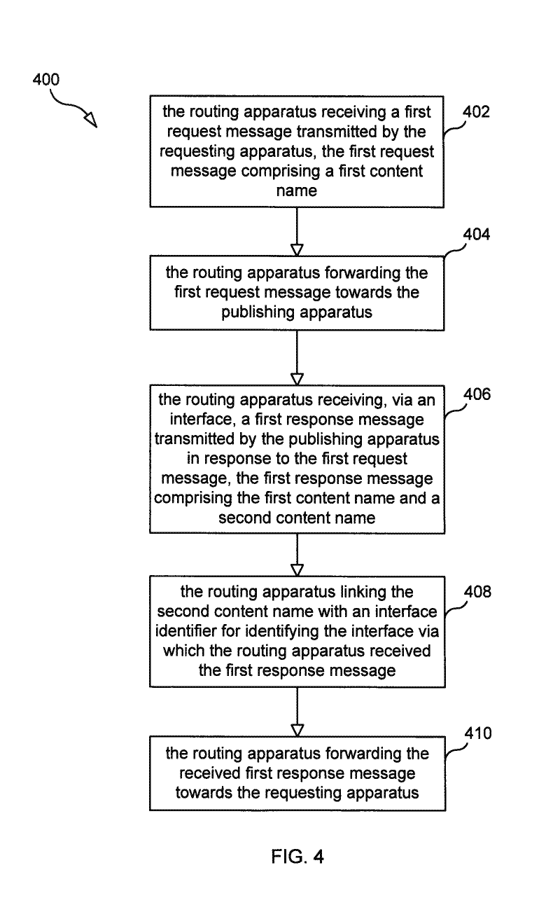

FIG. 4 is a flow chart illustrates a process 400, according to some embodiments, performed by routing apparatus 104 (or “router 104” for short). In step 402, router 104 receives first request message 302 (see the message flow diagram shown in FIG. 3), which was transmitted by RA 102. As discussed above, message 302 includes a first content name (“name1”). In step 404, router 104 forwards message 302 towards a publishing apparatus (in this example, the router 104 forwards message 302 to PA 106). In some embodiments, router 104 forwards message 302 towards a publishing apparatus by: examining a routing table to determine the interface of router 104 that is logically linked with the content name included in message 302 and then transmits message 302 via the determined interface. In addition to forwarding message 302, router 104 updates a database (a.k.a., an “interest database”) to logically link the content name included in message 302 (i.e., “name1”) with the interface via which router 104 received message 302, which in this example is interface I1. For example, in some embodiments, router 104 adds to the interest database a database record comprising a first field that stores the content name included in message 302 (“name1”) and a second field that stores an identifier identifying interface I1, thereby linking the content name with the interface identifier. In CCN, such a database is referred to as a Pending Interest Table (PIT).

In step 406, router 104 receives, via the interface over which it forwarded message 302 (i.e., interface I4 in this example), first response message 304 transmitted by PA 106 as a result of PA 106 receiving message 302. As discussed above, first response message 304 includes not only the first content name (i.e., “name1”), but also the second content name (i.e., “name2”). In response to receiving first response message 304, router 104 performs steps 408 and 410. In step 408, router 104 links the second content name (“name2”) with an interface identifier for identifying the interface via which router 104 received first response message 304 (in this example, the interface is interface I4). For example, in step 408, router 104 may add to a PIT a record comprising name2 and the identifier for interface I4. In embodiments in which response message 304 includes an Interest_name (discussed above), router 104 is configured to link the Interest_name with the interface identifier for the interface over which message 304 was received. Thus, in some embodiments, in performing step 408, router 104 extracted name2 from the data request field of message 304 (or from the currently_requested_data attribute) and, consequently, linked name2 with the interface identifier identifying interface I4.

In step 410, router 104 forwards first response message 304 towards RA 102. More specifically, in some embodiments, step 410 includes the steps of: router 104 determining which of its interfaces is linked with the first content name, which may be accomplished by consulting the interest database (e.g., PIT) mentioned above, and router 104 transmitting message 304 out the determined interface. In addition, after performing step 410, router 104 may update the interest database by removing from the interest database the information (e.g. record) that linked first content name “name1” with an interface identifier.

As discussed above, RA 102 will eventually receive first response message 304 and, in turn, generate and transmit a second response message 306, which will be received by router 104, and, like first response message 304, may include a Data_name, an Interest_name and a Content Object (i.e., like first response message 304, second response message 306 may be a Combined Message).

In response to receiving second response message 306, in some embodiments router 104: extracts from message 306 the Data_name, uses the extracted name and a database (e.g., a PIT) to determine whether the database includes an interface identifier linked with the extracted name, and forwards second response message 306 out the interface identified by the interface identifier linked with the extracted name in the database. Additionally, in response to receiving second response message 306, in some embodiments router 104 determines whether message 306 includes an Interest_name and, if so, obtains the Interest_name and updates a database (e.g., a PIT) to link the obtained Interest_name with the interface over which router 104 received the second response message 306. In this way, if router 104 subsequently receives a response message (e.g., a Data message or a Combined Message) containing a Data_name that matches the Interest_name, router 104 will be able to determine the correct interface over which the subsequent response message should be forwarded.

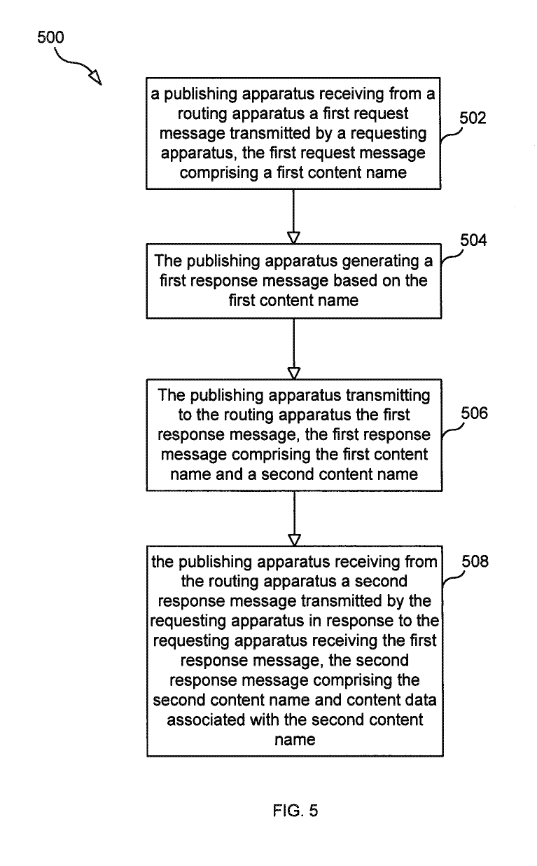

FIG. 5 is a flow chart illustrates a process 500, according to some embodiments, performed by publishing apparatus (PA) 106. In step 502, PA 106 receives from a routing apparatus (e.g., router 104) a first request message comprising a first content name (e.g., message 302) transmitted by a requesting apparatus (e.g., RA 102), the first request message containing a first content name, which in this case is an Interest_name. In response to receiving the first request message, PA 106 a) generates a first response message (e.g., message 304) based on the first content name (step 504), and b) transmits to the routing apparatus the first response message (step 506). The first response message contains, at the least, the first content name and a second content name, which in this case is a second Interest_name. The first response message may also contain a Content Object obtained by PA 106 using the first content name. In step 508, after transmitting to the routing apparatus the first response message, PA 106 receives from the routing apparatus a second response message (e.g., message 306) transmitted by the requesting apparatus in response to the requesting apparatus receiving the first response message transmitted by PA 106. The second response message contains the second content name and may also contain content data associated with the second content name, such as, for example, content data obtained by the requesting apparatus using the second content name. Also, as discussed above, the second response message may include an Interest_name, making the second response message a Combined Message. If the second response message is a Combined Message, then PA 106 generates a third response message and transmits the third response message so that it can be received by the originator of the second response message. This third response message may also be a Combined Message. In this way, an N-way commit protocol can be achieved.

Interest Aggregation:

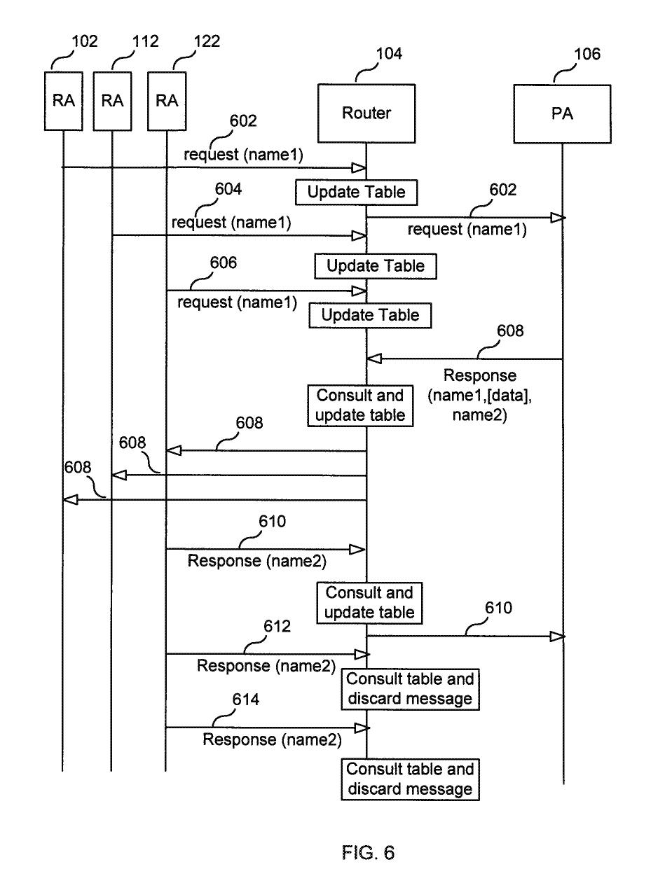

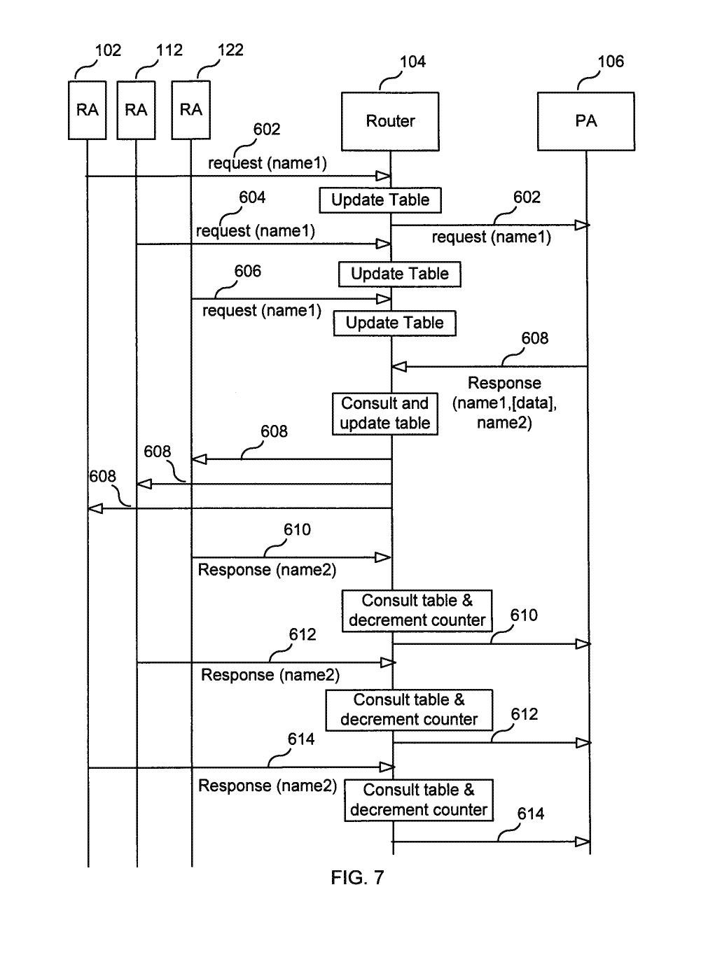

FIGS. 6 and 7 are message flow diagrams illustrating an Interest aggregation issue. As shown in FIGS. 6 and 7, RAs 102, 112, and 122 transmit request messages 602, 604 and 606, respectively. Each request message 602, 604, and 606 is requesting the same piece of content. For example, each message 602, 604, 606 contains the same Data_name (i.e., “name1”). In this scenario, message 602 is received by router 104 prior to messages 604 and 606. Accordingly, router 104 forwards message 602 (assuming the requested content is not cached in router 104) towards PA 106 and simply drops messages 604 and 606. Nevertheless, router 104 updates its interest database (e.g., PIT) based on each of messages 602, 604, and 606. More specifically, the Data_name (“name1”) is linked with the interfaces over which router 104 received messages 602, 604, and 606. In this example, name1 is linked with a total of three interfaces, namely interfaces I1, I2 and I3, because message 602 was received via interface I1, message 604 was received via interface I2, and message 606 was received via interface I3.

Subsequently, router 104 receives a response message 608 transmitted by PA 106 in response to PA 106 processing request message 602. In this example, response message is a Combined Message, and, therefore, includes not only a Data_name (“name1”) that is identical to the Interest_name included in the request message 606 that caused PA 106 to transmit response message 608, but also an Interest_name (“name2”). In response to receiving response message 608, router 104 consults its interest database to determine the interface(s) over which router 104 is to forward message 608. That is, router 104 consults the interest database to determine the one or more interfaces that are linked with the Data_name included in response message 608. Router 104 then forwards message 608 out each of the determined one or more interfaces (in this case, interfaces I1, I2, and I3) so that message 608 can be received by RAs 102, 112, 122. Additionally, router 104 adds to the interest database a record linking the Interest_name (“name2”) with the interface through which router 104 received message 608, which in this case is interface I4.

Each of RA 102, 112, and 122 will respond to response message 608 by transmitting a respective response message 610, 612, 614, each of which at least contains a Data_name whose value is name2 (i.e., the value of the Interest_name in message 608). That is, response messages 610, 612 and 614 may be Combined Messages or simply Data messages. In this example, RA 102 was the first to transmit its response message (i.e., message 610). When router 104 receives response message 610, router 104 uses the Data_name (i.e., “name2”) included in the message 610 and the interest database to determine the interface that is linked with the name name2, which interface in this case is interface I4 (see FIG. 1). Once the interface is determined, router 104 transmits message 610 out the determined interface.

If router 104 is configured such that, after router determines the interface that is linked with name2, router 104 removes from the interest database the information linking name2 with that interface, then when router 104 receives response messages 612 and 614, both of which contain name2 as the Data_name, router 104 will not be able to determine any interface that is linked with name2, and, thus, router 104 will drop messages 612 and 614 as shown in FIG. 6.

Accordingly, in some embodiments, router 104 is configured such that it does not prematurely remove from the interest database the information linking name2 with an interface of router 104. To accomplish this, in some embodiments, when router receives first response message 608, router 104 not only adds to the interest database information linking name 2 with the identifier identifying the interface through which router 104 received message 608, but also stores together with said linking information a counter that is set to the number of interfaces with which the name1 (i.e., the Data_name of message 608) is linked in the interest database at the time message 608 is received. In this example and as described above, at the time message 608 was received at router 104, router 104's interest database linked the name1 with a total of three interfaces (i.e., interfaces I1, I2, and I3).

In this scenario, router 104 does not delete from the interest database the information linking name2 with an interface identifier until the counter has a value of zero. Further, router 104 is configured to decrement the counter each time router 104 receives a response message containing name2 as the Data_name. Accordingly, the counter will be greater than zero when router 104 receives response messages 610, 612, and 614, and, thus, router 104 will be able to correctly transmit each of these response messages using the correct interface (i.e., the interface linked with the second content name, name2), as shown in FIG. 7. When the counter reaches a value of zero (0), then router 104 may delete from the interest database the information (e.g., database record) linking name2 with an interface identifier.

Caching Combined Messages

As described above, a Combined Message is a response message transmitted by an apparatus in response to the apparatus receiving a request message containing a first Interest_name (e.g., “name1”), wherein the response message includes: a Data_name (e.g., “name1”) that is the same as the first Interest_name and a second Interest_name (e.g., “name2”).

Normally in CCN a router may cache a Content Object arriving in a response message (called a “Data message” in CCN) and later use the cached copy to answer a request message (called an “Interest message” in CCN) referring to the same name. Described below are a few alternative rules on caching the Content Object carried in a Combined message.

Alternative #1: A router shall not cache a Content Objects arriving in a Combined messages.

Alternative #2: A router may cache a Content Objects arriving in a Combined message in the same manner as if the Content Object arrived in a Data message. All aspects of caching (such as expiry time) are as with normal CCN, that is, the source of the Combined message can mark this Content Object as non-cacheable (zero expiry time), in which case the routers must not cache it.

Alternative #3: A router may cache a Content Object arriving in a Combined messages, but if it does, then the router shall also cache the Interest_name included in the Combined Message. As an additional rule, if later an Interest message arrives to the router to Name_D (that is, to the name of a cached Content Object from a Combined message), instead of a Data message, the router should respond with a Combined message containing both the cached Content Object and the Interest_name that was cached along with the Content Object. Other aspects of caching (such as expiry time) are as with normal CCN, that is, the source of the Combined message can mark this Content Object as non-cacheable (zero expiry time), in which case the routers must not cache it. This can have the benefit of reducing the load on the publishing apparatus.

Alternative #4: The Combined message contains a flag enabling the source of the Combined message to influence the caching of the interest part, that is, selecting between Alt #2 and Alt #3 on a per message basis. This way the publisher of the Content Object can signal whether the Content Object is meaningful without the attached interest part, or not, respectively.

Resolving the Interest part of a Combined Message from a Local Cache:

Normally, a CCN router responds to an Interest message with a Data message if the router's local cache holds the Content Object named in the Interest message. Described below are a few alternatives on what to do if a router has a cached Content Object matching the Interest name included in a Combined message.

Alternative #1: The Routers shall not check its cache for any Content Objecting corresponding to the Interest name of a Combined message.

Alternative #2: Upon receipt of a Combined Message, the Router shall determine whether its cache includes a Content Object matching the Interest name of the Combined message. If a hit is found, the router shall: transmit on the interface on which it received the Combined message a response message (e.g., a Data message or a Combined message) containing the matching Content Object and containing a Data name matching the Interest_name; convert the combined message into a Data message by removing the Interest_name from the Combined message; and process the Data message as per normal Data message processing rules.

Alternative #3: The Combined message contains a flag enabling the source of the Combined message to select between Alternative #1 and #2 above on a per-message basis.

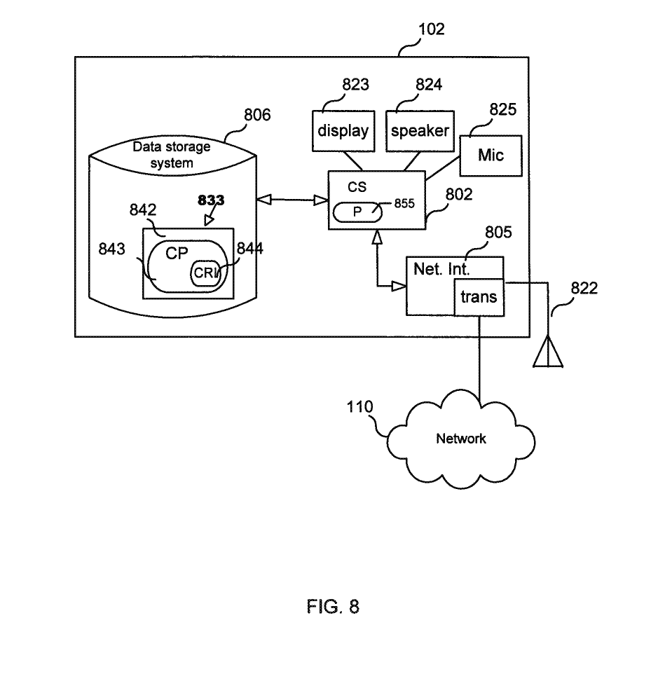

FIG. 8 illustrates a block diagram of a requesting apparatus, such as requesting apparatus 102. As shown in FIG. 8, requesting apparatus may include or consist of: a computer system (CS) 802, which may include one or more processors 855 (e.g., a microprocessor) and/or one or more circuits, such as an application specific integrated circuit (ASIC), field-programmable gate arrays (FPGAs), a logic circuit, and the like; a network interface 805, which includes a transceiver 866 that may be coupled to an antenna 822 or a network 110, for communicating with other devices; a data storage system 806, which may include one or more non-volatile storage devices and/or one or more volatile storage devices (e.g., random access memory (RAM)); a display 823, a speaker 824, and a microphone 825.

In embodiments where requesting apparatus 102 includes a processor 855, a computer program product (CPP) 833 may be provided. CPP 833 includes or is a computer readable medium (CRM) 842 storing a computer program (CP) 843 comprising computer readable instructions (CR1) 844 for performing steps described herein (e.g., one or more of the steps shown in FIG. 2). CP 843 may include an operating system (OS) and/or application programs. CRM 842 may include a non-transitory computer readable medium, such as, but not limited, to magnetic media (e.g., a hard disk), optical media (e.g., a DVD), solid state devices (e.g., random access memory (RAM), flash memory), and the like.

As further shown, data storage system 806 can be used to store various items. For example, DSS 106 may store: a database of pre-recorded voice segments 891, a database containing user satisfaction data (USD) 881, a database 881 (e.g., table) that maps each of a plurality of communications to one or more communication types, a rules database 883 for storing voice selection rules, and a satisfaction metric (SM) database 882. SM database 882 functions to associate one or more available voices with a set of one or more satisfaction metrics. In some embodiments, SM database is of the form shown in Table 3, above. That is, SM database 882, in some embodiments, functions to associate (i.e., map) a voice/communication-type pair to a set of satisfaction metrics.

In some embodiments, the CRI 844 of computer program 843 is configured such that when executed by computer system 802, the CRI causes the apparatus 102 to perform steps described above (e.g., steps described above with reference to the flow charts and message flows shown in the drawings). In other embodiments, apparatus 102 may be configured to perform steps described herein without the need for a computer program. That is, for example, computer system 802 may consist merely of one or more ASICs. Hence, the features of the embodiments described herein may be implemented in hardware and/or software.

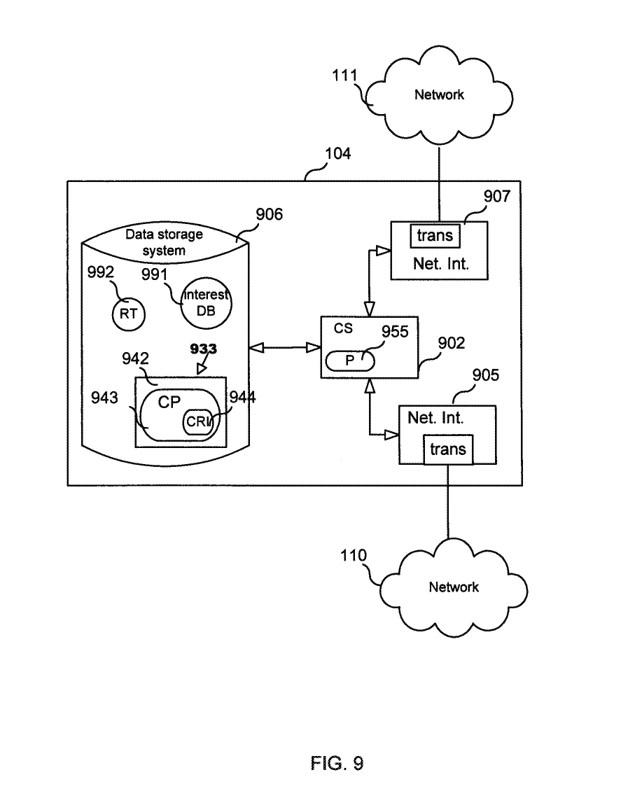

FIG. 9 illustrates a block diagram of a routing apparatus, such as routing apparatus 104. As shown in FIG. 9, apparatus 104 may include or consist of: a computer system (CS) 902, which may include one or more processors 955 (e.g., a microprocessor) and/or one or more circuits, such as an application specific integrated circuit (ASIC), field-programmable gate arrays (FPGAs), a logic circuit, and the like; a first network interface 905, which includes a transceiver 966 that may be coupled to a network 110; a second network interface 907, which includes a transceiver 967 that may be coupled to a network 111; and a data storage system 906, which may include one or more non-volatile storage devices and/or one or more volatile storage devices (e.g., random access memory (RAM)).

In embodiments where apparatus 104 includes a processor 955, a computer program product (CPP) 933 may be provided. CPP 933 includes or is a computer readable medium (CRM) 942 storing a computer program (CP) 943 comprising computer readable instructions (CRI) 944 for performing steps described herein (e.g., one or more of the steps shown in FIG. 4). CP 943 may include an operating system (OS) and/or application programs. CRM 942 may include a non-transitory computer readable medium, such as, but not limited, to magnetic media (e.g., a hard disk), optical media (e.g., a DVD), solid state devices (e.g., random access memory (RAM), flash memory), and the like.

As further shown, data storage system (DSS) 906 can be used to store various items. For example, DSS 106 may store an interest database 991 (e.g., a PIT) and a routing table 992.

In some embodiments, the CRI 944 of computer program 943 is configured such that when executed by computer system 902, the CRI causes the apparatus 104 to perform steps described above (e.g., steps described above with reference to the flow charts and message flows shown in the drawings). In other embodiments, apparatus 104 may be configured to perform steps described herein without the need for a computer program. That is, for example, computer system 902 may consist merely of one or more ASICs. Hence, the features of the embodiments described herein may be implemented in hardware and/or software.

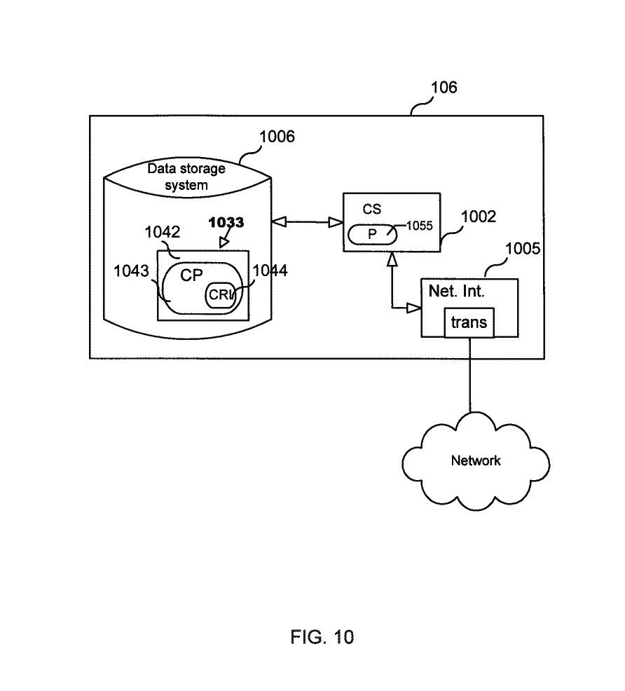

FIG. 10 illustrates a block diagram of a publishing apparatus, such as publishing apparatus 106. As shown in FIG. 10, apparatus 106 may include or consist of: a computer system (CS) 1002, which may include one or more processors 1055 (e.g., a microprocessor) and/or one or more circuits, such as an application specific integrated circuit (ASIC), field-programmable gate arrays (FPGAs), a logic circuit, and the like; a network interface 1005, which includes a transceiver 1066 that may be coupled to a network; and a data storage system 1006, which may include one or more non-volatile storage devices and/or one or more volatile storage devices (e.g., random access memory (RAM)).

In embodiments where apparatus 106 includes a processor 1055, a computer program product (CPP) 1033 may be provided. CPP 1033 includes or is a computer readable medium (CRM) 1062 storing a computer program (CP) 1063 comprising computer readable instructions (CR1) 1064 for performing steps described herein (e.g., one or more of the steps shown in FIG. 5). CP 1063 may include an operating system (OS) and/or application programs. CRM 1062 may include a non-transitory computer readable medium, such as, but not limited, to magnetic media (e.g., a hard disk), optical media (e.g., a DVD), solid state devices (e.g., random access memory (RAM), flash memory), and the like.

In some embodiments, the CR1 1064 of computer program 1063 is configured such that when executed by computer system 1002, the CRI causes the apparatus 106 to perform steps described above (e.g., steps described above with reference to the flow charts and message flows shown in the drawings). In other embodiments, apparatus 106 may be configured to perform steps described herein without the need for a computer program. That is, for example, computer system 1002 may consist merely of one or more ASICs. Hence, the features of the embodiments described herein may be implemented in hardware and/or software.

While various embodiments have been described above, it should be understood that they have been presented by way of example only, and not limitation. Thus, the breadth and scope of the present invention should not be limited by any of the above-described exemplary embodiments. Moreover, any combination of the above-described elements in all possible variations thereof is encompassed by the invention unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for information centric networking, the method comprising:
a requesting apparatus transmitting a first request message towards a routing apparatus for forwarding the first request message towards a publishing apparatus, the first request message comprising a first content name;
after transmitting the first request message, the requesting apparatus receiving a first response message transmitted by the publishing apparatus in response to the publishing apparatus receiving the first request message, the first response message comprising the first content name and a second content name; and
in response to receiving the first response message, the requesting apparatus:
a) obtaining content data using the second content name;
b) generating a second response message comprising the obtained content data and the second content name, and
c) transmitting towards the routing apparatus the second response message.

2. The method of claim 1, wherein the first request message is a CCN Interest message and the first content name is a name for identifying a requested content object.

3. The method of claim 1, wherein the second response message further comprises a third content name and the second response message is a Combined Message.

4. The method of claim 3, further comprising the requesting apparatus receiving a third response message transmitted by the publishing apparatus in response to the publishing apparatus receiving the second response message, wherein the third response message comprises the third content name and a content object obtained by the publishing apparatus using the third content name.

5. The method of claim 4, wherein
the third response message further comprises a fourth content name, and
the method further comprises the requesting apparatus performing the following steps in response to receiving the third response message:
d) obtaining content data using the fourth content name;
e) generating a fourth response message comprising the fourth content name and the content data obtained using the fourth content name, and
f) transmitting towards the routing apparatus the fourth response message.

6. A requesting apparatus, comprising:
a network interface for transmitting and receiving messages; and
a computer system configured to i) generate a first request message comprising a first content name; and ii) employ the network interface to transmit the first request message towards a routing apparatus for forwarding the first request message towards a publishing apparatus, wherein
the computer system is further configured such that, in response to the requesting apparatus receiving a first response message transmitted by the publishing apparatus in response to the publishing apparatus receiving the first request message, wherein the first response message comprises the first content name and a second content name, the computer system:
a) obtains content data using the second content name;
b) generates a second response message comprising the obtained content data and the second content name, and
c) transmits towards the routing apparatus the second response message.

7. The requesting apparatus of claim 6, wherein the first request message is a CCN Interest message and the first content name is a name for identifying a requested content object.

8. The requesting apparatus of claim 6, wherein the second response message further comprises a third content name and the second response message is a Combined Message.

9. The requesting apparatus of claim 8, wherein the computer system is further configured such that, in response to the requesting apparatus receiving a third response message transmitted by the publishing apparatus in response to the publishing apparatus receiving the second response message, wherein the third response message comprises the third content name and a fourth content name, the computer system:
d) obtains content data using the fourth content name;
e) generates a fourth response message comprising the fourth content name and the content data obtained using the fourth content name, and
f) transmits towards the routing apparatus the fourth response message.

10. A method for information centric networking in a communication system having a first requesting apparatus, a routing apparatus, and a publishing apparatus, the method comprising:
the routing apparatus receiving a first request message transmitted by the first requesting apparatus, the first request message comprising a first content name;
the routing apparatus forwarding the first request message towards the publishing apparatus;
after forwarding the first request message towards the publishing apparatus, the routing apparatus receiving, via a network interface, a first response message transmitted by the publishing apparatus in response to the first request message, the first response message comprising the first content name and a second content name;
the routing apparatus forwarding the received first response message towards the first requesting apparatus and linking the second content name with a network interface identifier for identifying the interface via which the routing apparatus received the first response message.

11. The method of claim 10, wherein the first response message further comprises a content object obtained by the publishing apparatus using the first content name.

12. The method of claim 10, further comprising:
prior to receiving the first response message, the routing apparatus receiving a second request message transmitted by a second requesting apparatus, the second request message comprising the first content name;
in response to receiving the second request message, the routing apparatus linking the first content name with a network interface identifier for identifying the interface via which the routing apparatus received the second request message;
the routing apparatus forwarding the first response message towards the second requesting apparatus.

13. The method of claim 12, further comprising:
the routing apparatus determining the number of interfaces associated with the second content name;
the routing apparatus setting a counter to a value based on the determined number of interfaces;
the routing apparatus receiving a third response message comprising the second content name; and
in response to receiving the third response message, the routing apparatus determining the interface identifier with which the second content name is linked and adjusting the value of the counter.

14. The method of claim 13, wherein
the step of linking the second content name with a network interface identifier for identifying the interface via which the routing apparatus received the first response message comprises the routing apparatus adding to a network interest database a record comprising the second content name and the interface identifier, and
the method further comprises:
the routing apparatus determining whether the value of the counter has reached a predetermined threshold, and
the routing apparatus removing the record form the interest database as a result of determining that the value of the counter has reached the predetermined threshold.

15. A routing apparatus, comprising
a set of network interfaces for transmitting and receiving message, the set of interfaces comprising a first interface and a second interface; and
a computer system, wherein
the computer system is configured such that, in response to the routing apparatus receiving, via the first interface, a first request message transmitted by a first requesting apparatus, wherein the first request message comprises a first content name, the computer system employs said second interface to forward the first request message towards a publishing apparatus, and
the computer system is further configured such that, in response to the routing apparatus receiving, via one of said interfaces, a first response message transmitted by the publishing apparatus in response to the first request message, wherein the first response message comprises the first content name and a second content name, the computer system employs the first interface to forward the received first response message towards the first requesting apparatus and links the second content name with a network interface identifier for identifying the interface via which the routing apparatus received the first response message.

16. The routing apparatus of claim 15, wherein
the computer system is further configured such that, in response to the routing apparatus receiving a second request message transmitted by a second requesting apparatus, wherein the second request message comprises the first content name and was received by the routing apparatus prior to the routing apparatus receiving the first response message, the computer system links the first content name with a network interface identifier for identifying the interface via which the routing apparatus received the second request message, and
the computer system is further configured to employ one of said interfaces to forward the first response message towards the second requesting apparatus.

17. The routing apparatus of claim 16, wherein
the computer system is further configured to: determine the number of interfaces associated with the second content name, and set a counter to a value based on the determined number of interfaces, and
the computer system is further configured such that, in response to the routing apparatus receiving a third response message comprising the second content name, the computer system determines the interface identifier with which the second content name is linked and adjusts the value of the counter.

18. The routing apparatus of claim 17, wherein
the computer system is configured to link the second content name with a network interface identifier for identifying the interface via which the routing apparatus received the first response message by adding to a network interest database a record comprising the second content name and the interface identifier, and
the computer system is further configured to determine whether the value of the counter has reached a predetermined threshold and remove the record form the interest database as a result of determining that the value of the counter has reached the predetermined threshold.

19. A method for information centric networking, the method comprising:
a publishing apparatus receiving a first request message transmitted by a requesting apparatus, the first request message comprising a first content name;
in response to receiving the first request message, the publishing apparatus: a) generating a first response message based on the first content name, and b) transmitting the first response message, the first response message comprising: the first content name and a second content name; and
after transmitting the first response message, the publishing apparatus receiving a second response message transmitted by the requesting apparatus in response to the requesting apparatus receiving the first response message transmitted by the publishing apparatus, the second response message comprising: the second content name and content data associated with the second content name.

20. The method of claim 19, wherein
the method further comprises the publishing apparatus using the first content name to obtain a first content object, and
the first response message further comprises the first content object.

21. The method of claim 19, wherein the second response message further comprises a third content name and the second response message is a Combined Message.

22. The method of claim 21, further comprising:
in response to receiving the second response message, the publishing apparatus 1) obtaining a content object using the third content name, 2) generating a third response message comprising the third content name, a fourth content name, and the content object obtained using the third content name, and 3) transmitting the third response message.

23. A publishing apparatus, comprising:
a network interface for transmitting and receiving messages; and
a computer system configured, such that, in response to the publishing apparatus receiving a first request message, the publishing apparatus:
a) uses a first content name included in the first request message to obtain a first content object;
b) generates a first response message comprising, the first content name, the obtained first content object and a second content name, and
c) employs the network interface to transmit towards a routing apparatus the first response message.

24. The publishing apparatus of claim 23, wherein the first request message is a CCN Interest message and the first content name is a name for identifying a requested content object.

25. The publishing apparatus of claim 23, wherein the second response message further comprises a third content name and the second response message is a Combined Message.

26. The publishing apparatus of claim 25, wherein
in response to receiving the second response message, the publishing apparatus 1) obtains a content object using the third content name, 2) generates a third response message comprising the third content name, a fourth content name, and the content object obtained using the third content name, and 3) transmits the third response message.
